(19) United States
(12) Patent Application Publication
(10) Pub. No.: US 2026/0338111 A1
(43) Pub. Date: Oct. 29, 2026

(54) THREE-STREAM AXIAL TURBINE ENGINE WITH A SEALED HEAT EXCHANGER IN THE THIRD STREAM

(71) Applicant: SAFRAN AIRCRAFT ENGINES, Paris (FR)

(72) Inventors: Valentin Sébastien Simon AVOYNE, Samois sur Seine (FR); Bruno Albert BEUTIN, EVRY (FR); François Marie Paul MARLIN, VILLIERS SOUS GREZ (FR)

(21) Appl. No.: 19/114,183

(22) PCT Filed: Sep. 14, 2023
(86) PCT No.: PCT/EP2023/075324

§ 371 Date: Mar. 21, 2025

(30) Foreign Application Priority Data
Sep. 23, 2022 (FR) FR2209655

(51) Int. Cl. F02C 7/18

(52) U.S. Cl. CPC F02C 7/18; F05D 2260/213

(57) ABSTRACT

A turbomachine including a first separation lip capable of separating an incoming air flow into a radially internal air flow and a secondary air flow; a second separation lip capable of separating the radially internal air flow into a primary flow and a tertiary flow traveling through a tertiary flow vein radially external to a primary flow vein traversed by the primary flow; a heat exchanger arranged in the tertiary flow vein; and an internal casing. The heat exchanger includes an upstream part including a collar extending in a projecting manner and upstream from a body of the exchanger, the collar being received in a floating manner in a groove extending circumferentially in the internal casing.

### TECHNICAL FIELD

The invention relates to the field of turbomachines and more particularly to three-flow turbomachines. The invention relates to the arrangement of a heat exchanger intended for cooling the oil of the turbomachine.

### PRIOR ART

Climate change is a major concern for many legislative and regulatory bodies around the world. Indeed, various restrictions on carbon emissions have been, are being or will be adopted by various states. In particular, an ambitious standard applies both to new types of aircraft but also to those in circulation requiring the implementation of technological solutions in order to make them compliant with current regulations. Civil aviation has been mobilizing for several years now to make a contribution to the fight against climate change.

Technological research efforts have already made it possible to significantly improve the environmental performance of aircraft. The Applicant takes into consideration the impact factors in all phases of design and development to obtain less energy-intensive, more environmentally friendly aeronautical components and products whose integration and use in civil aviation have moderate environmental consequences with the aim of improving the energy efficiency of aircraft.

Consequently, the Applicant is constantly working to reduce its negative climate impact by using methods and operating virtuous development and manufacturing processes and minimizing greenhouse gas emissions to the minimum possible in order to reduce the environmental footprint of its activity.

This sustained research and development work covers new generations of aircraft engines, the weight reduction of aircraft, particularly through the materials used and the lighter on-board equipment, the development of the use of electrical technologies to provide propulsion, and, as an essential complement to technological progress, aeronautical biofuels.

In this context, the invention relates more particularly to the aspects related to the arrangement of heat exchangers in turbomachines. Indeed, in a turbomachine, it is generally necessary to cool the oil of the lubrication circuit. It is known to arrange one or more heat exchanger(s) in the tertiary flow of a three-flow turbomachine, that is to say in the radially intermediate flow between the primary flow directed towards the combustion chamber and the secondary, external flow.

The integration of an exchanger in the third flow, confined between the primary flow and the secondary flow, poses difficulties of assembly and accessibility in the event of maintenance, but also constraints related to sealing in operation due to the thermal expansion of the exchanger. A “brick” type exchanger inspired by document FR 3 089 248 A1 does not meet these constraints and is therefore not suitable for the third flow.

The integration of an exchanger into a third flow of a three-flow turbomachine therefore presents challenges linked to its size, its assembly, its accessibility, its operation and also the overall mass of the means used to fix it to the casing.

### DISCLOSURE OF THE INVENTION

### Technical problem

The present invention aims to overcome at least one of the disadvantages of the aforementioned prior art. More particularly, the invention aims to propose a simple, efficient, and economical solution to address the disadvantages of the design/manufacture of prior art turbomachines. In particular, the invention aims to propose a solution that allows effective cooling in a limited space while ensuring the accessibility of the heat exchanger during maintenance operations, and ensuring proper sealing and the safety of the turbomachine in case of fire, but also without adding weight and without hindering the performance of the turbomachine.

### Technical Solution

To this end, the present invention relates to a turbomachine, comprising:
a first separation lip capable of separating an incoming airflow into a radially internal airflow and a radially external airflow, said secondary flow;
a second separation lip capable of separating the radially internal airflow into a primary flow and a tertiary flow, the latter flowing through a tertiary flow vein radially external to a primary flow vein traversed by the primary flow;
a heat exchanger disposed in the tertiary flow vein; and
an internal casing;
the turbomachine being characterized in that
the heat exchanger comprises a body and a flange extending radially inward and protruding from the body, the flange being fixed to the internal casing, the heat exchanger further comprising, upstream of the flange, an upstream part comprising a collar extending protrudingly and upstream from the body of the heat exchanger, said collar being received in a floating manner in a groove extending circumferentially in the internal casing.

Advantageously, the mounting of the collar in the groove is devoid of any fixation and avoids creating areas of mechanical stress when the heat exchanger undergoes thermal expansions. To this end, the floating mounting of the collar in the groove allows for expansion deformations in the axial, radial, and circumferential directions. Preferably, a downstream part of the heat exchanger comprises a groove extending circumferentially, the turbomachine further comprising an internal ferrule of the tertiary flow vein which comprises an upstream portion received in the groove. The internal ferrule as well as the internal casing preferably correspond to an inter-vane shroud of the turbomachine which is disposed between the primary flow vein and the tertiary flow vein. Advantageously, the casing and the internal ferrule are in aerodynamic continuity with the tertiary flow vein, and preferably constitute a radially internal guiding wall of the tertiary flow.

Advantageously, the mounting of the upstream portion of the ferrule in the groove is floating and devoid of any fixation. This avoids creating areas of mechanical stress when the heat exchanger undergoes thermal expansions, allowing for expansion deformations in the axial, radial, and circumferential directions.

According to an advantageous embodiment of the invention, the fixing flange extends circumferentially over at most 50% of a circumferential extent of the heat exchanger.

According to an advantageous embodiment of the invention, the fixing flange is disposed in a central position of the heat exchanger, in a circumferential direction.

Advantageously, the flange being circumferentially centered on the heat exchanger, it allows free expansion of the heat exchanger by permitting it to extend tangentially in the tertiary flow vein.

According to an advantageous embodiment of the invention, the flange is fixed to the casing by means of fixing elements allowing a blind fixation.

In this configuration, the heat exchanger is advantageously mounted directly in the groove of the internal casing, such mounting being carried out from downstream to upstream, and by simple insertion, thus facilitating the accessibility and maintainability of the heat exchanger.

According to an advantageous embodiment of the invention, the turbomachine comprises a first thermal insulating seal disposed in the groove and interposed between the casing and the heat exchanger.

This seal ensures the sealing between the heat exchanger and the internal casing, in order to avoid air leaks in an inter-vane compartment, while avoiding the addition of fixing elements for the upstream part of the heat exchanger to the casing which would aim to rigidify the heat exchanger and prevent its deformation.

Preferably, the turbomachine comprises a second thermal insulating seal disposed in the groove and interposed between the heat exchanger and the ferrule.

The second seal limits the deformation of the ferrule that would appear due to thermal conduction with a hot heat exchanger. Thus, it eliminates the need for fixing elements for the ferrule to the casing which would aim to rigidify the ferrule and prevent its deformation.

According to an advantageous embodiment of the invention, the turbomachine comprises structural arms extending radially through the tertiary flow vein and delimiting inter-arm spaces between them, the turbomachine comprising a heat exchanger in each inter-arm space, each of the heat exchangers comprising a body and a flange extending radially inward and protruding from the respective body, each flange being fixed to the internal casing, and each of the heat exchangers further comprising a lateral thermal insulating seal interposed between the heat exchanger and the adjacent structural arm.

In this configuration, the lateral seal is capable of ensuring the sealing of the heat exchanger in the circumferential direction in the vein, particularly during a contraction of the exchanger in the inter-vane space following a dilation of said exchanger. The lateral seal allows for the absorption of circumferential gaps between the exchanger and the structural arm so that said seal always remains in contact and sealed with the structural arm.

According to an advantageous embodiment of the invention, each of the exchangers comprises the first seal and two lateral thermal insulating seals, said lateral seals being integrally formed with the first seal. To this end, the first seals ensure, with the structural arms, the sealing and thermal insulation over 360° around the longitudinal axis.

Preferably, the second thermal insulating seal is common to all the exchangers and is interposed between the exchangers and the ferrule. Advantageously, the second seal ensures the sealing and thermal insulation over 360° around the longitudinal axis.

According to an advantageous embodiment of the invention, the flange is disposed in a downstream half of the exchanger, and downstream of said flange, the exchanger further comprises a downstream part to which a fire wall forming a thermal shield is attached.

Preferably, the downstream part has an axial length between 20% and 50% of the axial length of the exchanger. This facilitates assembly/disassembly from the downstream side, as the flange is easily accessible, without mechanically unbalancing the cantilevered mounting of the downstream part of the exchanger.

Advantageously, the fire wall corresponds to a fireproof wall that delays the propagation of a potential fire from the primary flow vein (from the combustion chamber, for example) to the rest of the aircraft (to the aircraft nacelle). Attaching the fire wall to the exchanger allows for a reduction in overall bulk but also facilitates the maintenance of these elements as no additional fixation for the fire wall is necessary.

The invention also relates to a method for removing a heat exchanger in a turbomachine according to one of the advantageous embodiments of the invention mentioned above, the method comprising the following steps:
disassembly of the fixing elements of the flange to the casing;
removal of the exchanger by an axial displacement towards the downstream side. Advantageously, the removal of the exchanger is partly facilitated by means of the collar floating in the groove and requiring only a simple manual withdrawal towards the downstream side.

The invention also relates to a method for installing a heat exchanger in a turbomachine according to one of the advantageous embodiments of the invention mentioned above, the method comprising the following steps:
installation of the exchanger by an axial displacement towards the upstream side;
fixation of the fixing elements of the flange to the casing.

### Advantages of the Invention

The heat exchanger, in addition to being capable of effectively cooling the oil by exchanging heat with the air, ensures additional functions, such as: the arrangement of a fire wall while guaranteeing sealing and the constitution of a support for the ferrule. In this configuration, the number of intermediate parts that would have been introduced to separately meet the different required functions is significantly reduced, thus reducing the mass and manufacturing cost of the turbomachine of the invention. To this end, the assembly and disassembly of the heat exchanger are facilitated, thereby improving the maintainability of the turbomachine.

Moreover, the invention is particularly advantageous because the positioning of the heat exchanger at the level of the tertiary flow vein avoids hindering the engine's performance. This results in optimized energy efficiency and thrust, which advantageously allows for reduced fuel consumption and greenhouse gas emissions, thereby reducing the environmental impact of aircraft.

It is understood that each detail of an embodiment below can be combined with each other detail of the other embodiments.

### BRIEF DESCRIPTION OF THE DRAWINGS

FIG. 1 represents a longitudinal sectional view of a turbomachine according to the invention, said turbomachine comprising a heat exchanger in a tertiary flow vein;

FIG. 2 represents a front view of the tertiary flow vein of FIG. 1 comprising several heat exchangers;

FIG. 3 represents a sectional view of a mounting of the exchanger on an internal casing and of an internal shell on said exchanger;

FIG. 4 shows a perspective view of the exchanger including a thermal insulating gasket.

### DETAILED DESCRIPTION

In the following description, the terms “internal” and “external” refer to a positioning relative to the longitudinal axis of rotation of a turbomachine. The axial direction corresponds to the direction along the longitudinal axis of rotation of the turbomachine.

The radial direction is perpendicular to the longitudinal axis. Upstream and downstream refer to the direction of flow of a flow in the turbomachine.

The figures show the elements schematically and are not drawn to scale. In particular, some dimensions are enlarged to facilitate reading of the figures.

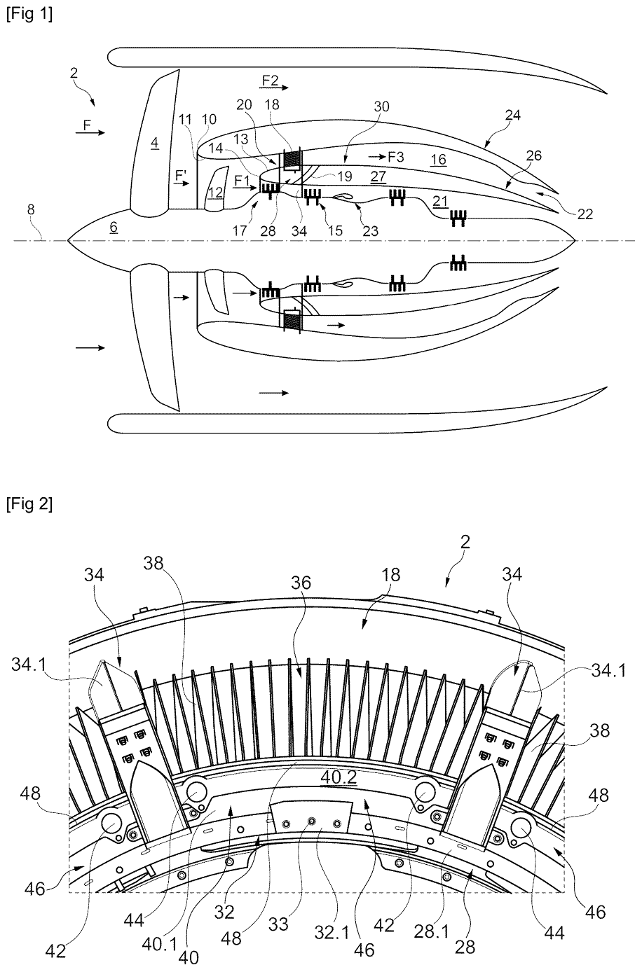

FIG. 1 illustrates a turbomachine 2 comprising a propeller 4 secured to a hub 6 rotating around a longitudinal axis 8.

The turbomachine 2 moves in an air flow F whose movement relative to the turbomachine 2 is generated by the rotation of the propeller 4 and the advancement of the aircraft on which the turbomachine 2 is mounted.

The air flow F is separated by a first separation lip 10 into a radially internal air flow F′ and a radially external air flow F2, called secondary flow F2. The propeller 4 can be arranged upstream of the first separation lip 10 or downstream.

The radially internal air flow F′ passes through a mobile wheel 12 which directs the latter towards a second separation lip 14 capable of separating the radially internal air flow F′ into a primary flow F1 and a tertiary flow F3, the latter being distinct from the secondary flow F2.

The first separation spout 10 comprises an inner wall forming a first outer guide wall 11 of the radially inner air flow F′, said first outer guide wall 11 forming a convex profile seen from said radially inner air flow F′.

The second separation lip 14 comprises an external wall forming a second external guide wall 13 of the radially internal air flow F′ having passed through the mobile wheel 12, said second external guide wall 13 forming a convex profile seen from the tertiary flow F3. For this purpose, the second external guide wall 13 corresponds to a radially internal guide wall 13 of the tertiary flow F3.

The tertiary flow F3 enters a tertiary flow vein 16 radially external to said primary flow F1. The tertiary flow F3 passes through a heat exchanger 18 arranged in the tertiary flow vein 16.

The heat exchanger 18 extends radially and axially in the tertiary flow vein 16, and preferably in an upstream section 20 of the tertiary flow vein 16, having a longitudinal section diverging in the direction of flow of the tertiary flow F3.

The heat exchanger 18 is arranged axially approximately between the high pressure compressor 15 and the low pressure compressor 17 called “booster” 17, at right angles to an inter-compressor casing.

The high pressure 15 and low pressure 17 compressors comprise rotating blades and rectifier blades arranged in a primary flow vein 21 crossed by the primary flow F1, the latter heading towards a combustion chamber 23.

A “VBV” channel 19 (Variabe Bleed Valve) opens axially downstream of the heat exchanger 18 into the tertiary flow 16. It provides a discharge function by returning part of the primary flow F1 to the tertiary flow F3 to prevent the high pressure compressor 15 from becoming blocked when the flow rate of the primary flow F1 becomes too low.

The heat exchanger 18 can extend continuously over 360° in the upstream section 20 of the vein 16 around the longitudinal axis 8 of the turbomachine 2. Preferably, the turbomachine 2 comprises several heat exchangers 18 extending in the tertiary flow vein 16 and subdividing the vein angularly in a discontinuous manner over 360° around the longitudinal axis 8. Each of said exchangers can independently provide a heat exchange function between the air and a fluid.

A single heat exchanger 18 can combine the cooling of several functions or oil circuits of the turbomachine, and this according to different parameters linked to the need for cooling the oil, i.e., inlet temperatures, flow rates, required outlet temperature or air conditions, the various circuits can be put in thermal contact or well insulated. The exchanger 18 and in particular its oil passages can withstand a low oil temperature of up to −54 °C.

The upstream section 20 of the tertiary flow vein 16 comprises an external fairing 24 and an inter-vein cowling 26, at least one of the external fairing 24 and inter-vein cowling 26 being rigidly connected to the exchanger 18. Preferably, the inter-vein cowling 26 is fixed to the exchanger 18. Such a fixing will be detailed later in this description.

The inter-vein cowling 26 comprises an internal casing 28, arranged axially between the high-pressure compressor 15 and the low-pressure compressor 17, and further comprises an internal shell 30 arranged downstream of the exchanger 18. In this configuration, the internal casing 28 and the internal shell 30 constitute, with the exchanger 18, the radially internal guide wall of the tertiary flow F3.

FIG. 2 is a front view, i.e. in the opposite direction to the air flow, of the tertiary flow vein 16 of FIG. 1 comprising several heat exchangers 18. It can be seen that the exchangers 18 are distributed angularly in the tertiary flow vein 16.

The turbomachine 2 comprises structural arms 34 extending radially across the tertiary flow vein 16 and delimiting between them inter-arm spaces 36. Preferably, the turbomachine 2 comprises between 2 and 20 structural arms 34.

At the same time, the inner ferrule may be single-piece and circumferentially continuous over 360°, or said ferrule may be subdivided into several internal ferrules of up to 5 ferrules.

The exchanger 18 is preferably obtained by additive manufacturing, said exchanger 18 extending circumferentially between two structural arms 34 in each inter-arm space 36.

The exchanger 18 comprises heat exchange surfaces 38 corresponding to oil passages and/or heat exchange surfaces with air extending radially and axially in the inter-arm space 36. An example of possible designs is detailed in patent applications BE2021/5978, BE2021/5979, BE2021/5980, BE2021/5982 and BE2021/5983, the design of the heat exchange surfaces 38 or of the internal oil passages not being the core of the present invention.

The exchanger 18 comprises a body 32 with a flange 32.1 extending radially internally and projecting from said body 32, such that the flange 32.1 is fixed to an annular flange 28.1 belonging to the internal casing 28. Said annular flange 28.1 is preferably continuous over 360° around the longitudinal axis of the turbomachine while the flange 32.1 of the exchanger 18 preferably has a restricted extent: the flange 32.1 is in a central position relative to the body 32, in the circumferential direction. This advantageously allows free rein for thermal expansions of the exchanger 18 by allowing the latter to extend tangentially in the inter-arm space 36. The direction of assembly of the exchanger 18 in the turbomachine is preferably from downstream to upstream. In this configuration, the fixing of the exchanger 18 to the internal casing 28 can be ensured by screwing. Thus, the flange 32.1 can be fixed to the annular flange 28.1 by means of two to six screws and/or bolts 33, and more preferably by means of three screws 33.

Preferably, the three screws 33 are circumferentially grouped so as to embed the flange 32.1 in the center of the exchanger 18 to tangentially release at least 50% of the circumferential extent of said exchanger 18.

The exchanger 18 also comprises a downstream portion 40 arranged downstream of the flange 32.1 and therefore mounted in a cantilever manner. This downstream portion 40 has an internal surface with an internal profile 40.1 for example cylindrical or conical around the longitudinal axis of the turbomachine, and a downstream surface having a downstream profile 40.2 substantially perpendicular to the longitudinal axis. Alternatively, the shape of the downstream portion 40 may be freer, as inspired by document EP 3 674 531 A1.

Preferably, the downstream surface 40.2 of the exchanger 18 comprises an oil inlet 42 at an angular end of the body 32, and an oil outlet 44 at a circumferentially opposite end.

The oil inlet 42 and the oil outlet 44 are fluidically connected to an oil collector and an oil distributor arranged in an internal portion of the body 32 of the exchanger 18 (not shown). Preferably, the internal portion of the body 32 may be hollow and devoid of material (apart from the oil collector and distributor and the fluid connections), so as to lighten the exchanger 18.

The downstream portion 40 also comprises on its downstream surface 40.2 a groove 48 extending circumferentially over the entire circumferential extent of the downstream portion 40. This allows the internal shell 30 of the inter-vein cowling 26 of FIG. 1 to be supported by the exchanger 18.

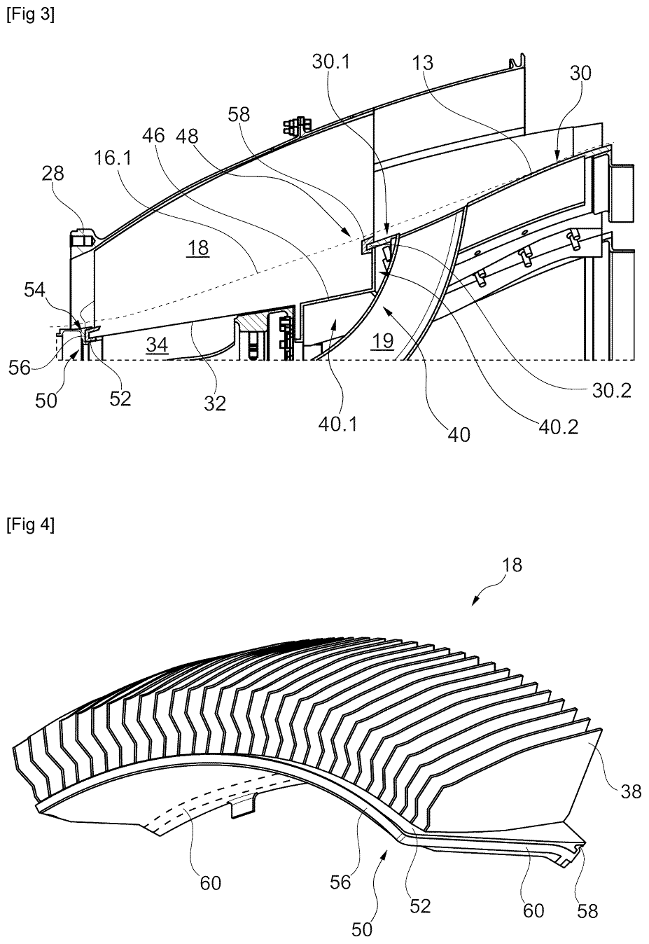

FIG. 3 shows a sectional view of a mounting of the exchanger 18 on the internal casing 28 and of the internal shell 30 on said exchanger 18.

It can be seen that the exchanger comprises an upstream portion 50 having a collar 52 extending projectingly and upstream from the body 32 of the exchanger 18, the collar 52 being received in a floating manner, and devoid of any fixing, in a groove 54 extending circumferentially in the internal casing 28. The collar 52 can describe a portion of a ring of constant radius relative to the axis 8 of the turbomachine.

Alternatively, the collar 52 can have variations in radii and the groove 54 can have a corresponding profile, in order to angularly index the exchanger during its assembly.

Advantageously, the collar 52 is arranged substantially flush with the radially internal guide wall 13, so as to follow the aerodynamic line 16.1 of the air flow in the tertiary flow vein 16 illustrated in FIG. 1.

In this configuration, the exchanger 18 is capable of being fixed blindly to the internal casing 28 of the turbomachine. The published patent document EP 3 441 579 A1 discloses an example of a blind mounting on a turbomachine which can be used here.

Blind fixing can be clever since the exchanger 18 is installed by an axial displacement upstream until the insertion of the collar 52 in the groove 54, and until the contact of the upstream flange 28.1 with the flange 32.1. There is therefore no access from upstream to hold a nut immobile with tools, and blind mounting makes it possible to overcome a design constraint on the upstream side.

The turbomachine comprises a first thermal insulating seal 56 arranged in the groove 54 and interposed between the casing 28 and the exchanger 18.

We can also see in FIG. 3, an upstream portion 30.1 of the shell 30 inserted in the groove 48. In this configuration, a second thermal insulating seal 58 is interposed in the groove 48 between the shell 30 and the exchanger 18.

Preferably, the first 56 and second 58 seals are made from a polyimide. Vespel® available from DuPont™. Advantageously, polyimide Vespel® is crack resistant at very high temperatures with excellent friction and wear characteristics, and does not produce significant gas evolution even at high temperatures.

Advantageously, the first and second seals 56, 58 have elastic mechanical properties allowing them to absorb part of the thermal expansions of the exchanger 18 in the axial and radial directions, so as to avoid propagation of mechanical stresses towards the casing 28 and the shell 30 and to protect against any risk of deformation and/or cracking.

In the configuration illustrated in FIG. 2, the first and second seals 56, 58 are interposed, respectively, between the exchangers 18 and the casing 28, and between the internal shell 30 and said exchangers 18.

The mounting of the ferrule 30 in the groove 48 is a floating mounting and devoid of any fixing, allowing, in the event of thermal expansion of the exchanger 18, to protect the ferrule 30 from any deformation by allowing expansions in the groove 48 in the axial, radial and circumferential directions.

In addition, the sealing of the assembly of the shell 30 and the exchanger 18 is guaranteed. This makes it possible to avoid any risk of air leaks towards the inter-vein compartment 27 of FIG. 1.

In this configuration, and with reference to FIGS. 1 and 3, the exchanger 18 is able to be easily removed by opening the external fairing 24 and opening the inter-vein cowling 26 by dismantling the shell 30 (preferably by axial displacement downstream), pipes connected to the exchanger 18 can be removed. At this stage, the fixing screws of the flange 32.1 on the casing 28 can be dismantled, and the exchanger 18 can be moved axially downstream by manual removal.

Advantageously, the disengagement of the collar 52 from the groove 56 is simple because the mounting of the latter two is carried out in a floating manner and without additional fixing.

Preferably, the exchanger 18 further comprises, and at the level of the downstream part 40, a fire wall 46 forming a heat shield making it possible to delay the propagation of a possible fire from the primary flow vein to the rest of the turbomachine.

The fire wall 46 can match the internal profile 40.1 and the downstream profile 40.2 of the downstream part 40, and can also extend radially to the flange 32.1 and up to the groove 48. Advantageously, and in addition to protecting the turbomachine from a fire spread, the fire wall 46 makes it possible to protect the shell 30 from the high temperatures of the exchanger 18.

The fire wall 46 preferably corresponds to a layer of insulating material such as a high-performance plastic. More preferably, the fire wall 46 is made of polyimide. Vespel® similarly to joints 56, 58.

FIG. 4 shows a perspective view of the exchanger 18 comprising a lateral thermal insulating seal 60 which can be interposed between each lateral side of the exchanger 18 and the adjacent structural arm (in the configuration of FIG. 2).

Preferably, the lateral seal 60 is of the same material as the first seal 56, and it is advantageously capable of ensuring the sealing of the exchanger 18 in the circumferential direction in the vein by absorbing circumferential gaps between the exchanger 18 and the adjacent structural arm. Thus, the lateral seal 60 always remains in contact with the structural arm in order to guarantee the sealing and thermal insulation of the corresponding structural arm.

Advantageously, each exchanger 18 comprises the first seal 56, the second seal 58, and two lateral seals 60. In this regard, said seals 56, 58, 60 may correspond to one and the same seal.

In this configuration, the common seal remains integral with the body of the exchanger and can advantageously be dismantled at the same time as the exchanger 18. A visual inspection of said common seal can then be carried out each time the exchanger 18 is dismantled, the replacement of said seal will thus be facilitated.

1. A turbomachine, comprising:
a first separation lip capable of separating an incoming airflow into a radially internal airflow and a radially external airflow;
a second separation lip capable of separating the radially internal airflow into a primary flow and a tertiary flow, the tertiary flow flowing through a tertiary flow vein radially external to a primary flow vein traversed by the primary flow;
a heat exchanger disposed in the tertiary flow vein; and
an internal casing;
wherein the heat exchanger comprises a body and a fixing flange extending radially inward and protruding from the body, the fixing flange being fixed to the internal casing, the heat exchanger further comprising, upstream of the fixing flange, an upstream part comprising a collar extending protrudingly and upstream from the body of the heat exchanger, said collar being received in a floating manner in a groove extending circumferentially in the internal casing.

2. The turbomachine according to claim 1, wherein the fixing flange extends circumferentially over at most 50% of a circumferential extent of the heat exchanger.

3. The turbomachine according to claim 1, wherein the fixing flange is disposed in a central position of the heat exchanger, in a circumferential direction.

4. The turbomachine according to claim 1, wherein the fixing flange is fixed to the casing with fixing elements allowing a blind fixation.

5. The turbomachine according to claim 1, further comprising a first thermal insulating seal disposed in the groove and interposed between the casing and the heat exchanger.

6. The turbomachine according to claim 5, further comprising structural arms extending radially through the tertiary flow vein and delimiting inter-arm spaces between them, the turbomachine further comprising a plurality of the heat exchangers, one of the heat exchangers being in each of the inter-arm spaces, each of the heat exchangers further comprising a lateral thermal insulating seal interposed between the heat exchanger and the adjacent structural arm.

7. The turbomachine according to claim 6, wherein each of the exchangers comprises the first seal and two lateral thermal insulating seals, said lateral seals being integrally formed with the first seal.

8. The turbomachine according to claim 1, wherein the fixing flange is disposed in a downstream half of the heat exchanger, and downstream of said fixing flange, the heat exchanger further comprises a downstream part to which a fire wall forming a thermal shield is attached.

9. A method for removing the heat exchanger in the turbomachine according to claim 4, the method comprising:
disassembling the fixing elements of the fixing flange to the internal casing; and
removing the heat exchanger by an axial displacement towards the downstream side.

10. A method for installing the heat exchanger in the turbomachine according to claim 4, the method comprising:
installing the heat exchanger by an axial displacement towards the upstream side; and
fixating the fixing elements of the fixing flange to the internal casing.
